(19) United States
(12) Patent Application Publication
(10) Pub. No.: US 2005/0025169 A1
(43) Pub. Date: Feb. 3, 2005

(54) Device and method for forwarding a message

(76) Inventors: Cesar Douady, Orsay (FR); Jean-Jacques Lecler, Cagnes Sur Mer (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 10/892,815

(22) Filed: Jul. 16, 2004

(30) Foreign Application Priority Data
Jul. 22, 2003 (FR) FR 0308905

(51) Int. Cl. H04L 12/54

(52) U.S. Cl. 370/415; 370/428

(57) ABSTRACT

Method of triggering the forwarding of a message in a device including an autonomous switching means including at least one input including a storage means provided with an input and an output. In this process, a coefficient representative of the ratio of the input clock gating frequency and output clock gating frequency is formulated, the quantity of data stored in the storage means of the input at which the said message arrives is compared with the product of the coefficient and of the length of the message, and the triggering is decided when the quantity of data stored in the storage means of the input at which the message arrives is greater than the product of the coefficient times the length of the message.

### BACKGROUND OF THE INVENTION

1. Field of the Invention

The present invention relates to a method and a device for forwarding a message.

2. Description of the Relevant Art

Interconnection networks are devices for forwarding messages between various agents or entities of a communication network. These interconnections networks are generally composed of two distinct parts which interact, namely a hardware part including physical links and a network controller, hard-wired or microprogrammed, which executes a low-level protocol, and a software part for effecting the interface with software functions of higher level.

An ideal interconnections network would certainly be a fully interconnected network, that is to say a network in which each pair of agents is connected by a point-to-point link. However, this is totally unrealistic onwards of a few tens of agents. It is therefore necessary for the interconnections network to be able to cater for all the communications between agents with a limited number of links per agent.

Specialized agents exist for performing routing or steering of messages flowing over the interconnections network. These interconnections networks include forwarding devices or routers (also known as “switches”), an organization of the network ensuring the link between the routers and the other agents, and a routing assembly that caters for the flow of messages within the organization of the network.

A router is an active agent of the interconnections network which receives as input messages coming from one or more agents and which steers or routes each of these messages respectively to their destination agent or to another router. This routing is performed by means of the address of the message destination agent, which is present in the header of the message to be routed.

The organization of a network constitutes the physical structure linking the various nodes or points of connections of an interconnections network.

The routing assembly manages the way in which a message is routed, or steered, from a source agent sending the message to a message destination agent through routers, along a routing path. A message is, of course, a string of computer data, that is to say a string of bits or bytes. Each messages includes a message header that chiefly includes the destination address of the message and the size of the message.

Any agent present in an interconnections network may send and/or receive messages. The routing technique determines the way in which the messages are forwarded from the sending agent to the destination agent. For a given interconnections network, there are various routing techniques, for which the objectives are to reduce the end of message latency, or end of message steering time, for a message, from the sending agent to the destination agent, to increase the overall throughput and to improve the overall reliability of the network. The latency includes all the waiting times due to the way in which the messages propagate in the network and more particularly through the devices for forwarding messages in charge of routing the messages. The throughput is the quantity of computer data that a link of the network can transport per unit time, and can be measured locally over a link of the interconnections network or globally over the whole of the interconnections network. The reliability of a network is important, since the probability of errors grows rapidly with the number of nodes in an interconnections network.

Numerous algorithms for routing in interconnection networks exist. Two of the most widespread are “store and forward” routing, and “wormhole” routing. These mechanisms are for example described at the following electronic addresses:
http://www.cs.bu.edu/˜best/crs/cs551/lectures/lecture-15.html
http://www.proj-mission.org/EE660/Gautam7.4.pdf,
http://www.comp.mq.edu.au/courses/comp439/lectures/comm_{—}4.pdf, and
http://www.cs.uh.edu/˜resch/TUTORIALS/SLIDES_TSS_{—}02/2-21-2002.pdf.

The “store and forward” routing algorithm requires that there be a storage means of first in first out or FIFO type of a size at least equal to the maximum length of a message. When the maximum size of a message is large, the hardware cost and the memory size are significant. Moreover the end of message latency will be relatively significant, and this may be critical for certain networks.

The “wormhole” routing algorithm minimizes the end of message latency, but does not make it possible to control the integrity of the message over intermediate nodes situated between the sending agent and the destination agent. The validity of the content of the message can then be controlled only at the level of the destination agent, that is to say of the final agent.

### SUMMARY OF THE INVENTION

In view of the foregoing, an aim of the invention is in particular to perform routing while having an end of message latency that is identical or as close as possible to the end of message latency of the “wormhole” routing algorithm but without having intra-message holes. The term hole is understood to mean a gap between two clock-gating pulses that is not used to forward data.

Thus, there is proposed a method of forwarding a message in a device including an autonomous switching means including at least one input including a storage means provided with an input and an output. A coefficient α representative of the ratio of the input clock gating frequency F_{w} and output clock gating frequency Fᵣ is formulated, the quantity of data stored in the storage means of the input at which the message arrives is compared with the product of the coefficient α and of the length of the message, and the triggering is decided when the quantity of data stored in the storage means of the input at which the message arrives is greater than the product of the coefficient α times the length of the message.

This routing makes it possible to have a minimum end of message latency, while approaching a zero probability of intra-message holes.

In an embodiment, the triggering is moreover decided when the message is completely stored in the storage means of the input at which the message arrives.

When a message is completely stored, so as not to increase the end of message latency, and cause a deadlock of a device, the message is forwarded immediately.

In an advantageous mode of implementation, the triggering is furthermore decided when the storage means of the input at which the message arrives is full. This may help to prevent deadlock of the device.

In an embodiment when the message includes a header, the length of the message is furthermore recovered in the header of the message. Knowledge of the length of the message being necessary, this information is recovered in the header of the message.

In an advantageous mode of implementation, the coefficient α is formulated through the following relation:

$$α = Max ( 0 ; 1 - \frac{{F}_{w}}{{F}_{r}} )$$

in which F_{w} is the write or input clock gating frequency of the input on which the message arrives, Fᵣ is the read or output clock gating frequency on the output on which the message is forwarded, and Max is the maximum function.

In an embodiment, when the input clock gating frequency F_{w} and output clock gating frequency Fᵣ are known constants, the parameter α is constant and is stored. In this case, it is not then necessary to recalculate the parameter α.

In an advantageous mode of implementation, when the clocks gating the inputs and the outputs are regular, the means of prediction includes a means for calculating the ratio of the input frequency F_{w} and output frequency Fᵣ.

Gating clocks are said to be regular when a clock pulse is sent even when there is no data forwarded, that is to say when there is an intra-message or inter-message hole. In this case it is then easy to obtain the ratio of the input frequency F_{w} and output frequency Fᵣ.

In a preferred mode of implementation, the parameter α is slaved to a predetermined rate of presence of intra-message holes in the messages.

When the ratio of the input frequency F_{w} and output frequency Fᵣ is not known, it is possible to obtain the number of intra-message holes. The aim is to tend to a very small number of intra-message holes, so as to improve the bit rate, without increasing the end of message latency.

There is also proposed a device for forwarding a message, including an autonomous switching means, at least one input of which includes a storage means provided with an input and an output. The device includes a means for formulating a coefficient α representative of the ratio of the input clock gating frequency F_{w} and output clock gating frequency Fᵣ, a means of comparing the quantity of data stored in the storage means of the input at which the message arrives with the product of the coefficient α and of the length of the message, and a means of triggering the forwarding of the message when the quantity of data stored in the storage means of the input at which the message arrives is greater than the product of the coefficient α times the length of the message.

In an embodiment, the means for triggering the forwarding of the message is able to activate itself moreover when the message is completely stored in the storage means of the input at which the message arrives.

In an embodiment, the means of triggering the forwarding of the message is able to activate itself moreover when the storage means of the input at which the message arrives is full.

In an embodiment when the message includes a header, the device includes a processing means able to recover the length of the message in the header of the message.

In an embodiment, the storage means of the input on which the message arrives is of first in first out type. This type of memory, also called a FIFO queue, is the most commonly used.

### BRIEF DESCRIPTION OF THE DRAWINGS

Other objects and advantages of the invention will become apparent upon reading the following detailed description and upon reference to the accompanying drawings in which:

FIG. 1 illustrates the “store and forward” routing algorithm, of the prior art;

FIG. 2 illustrates the “wormhole” routing algorithm, of the prior art;

FIG. 3 is a schematic diagram of a device according to the invention;

FIG. 4 illustrates an aspect of the method according to the invention; and

FIG. 5 illustrates a device according to the invention.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

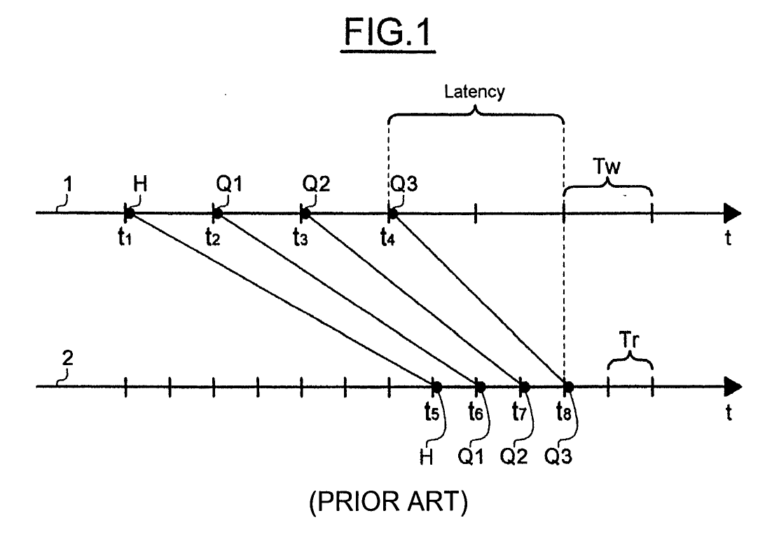

FIG. 1 illustrates the “store and forward” algorithm used by a prior art device including an autonomous switching means 5 and a storage means 7 of first in first out type with an input and an output, for at least one input of the device, respectively having clock gating frequencies F_{w} and Fᵣ. In this example, the clock gating frequencies are such that Fᵣ=2×F_{w}. The axis 1 represents time and the clock pulses on an input of the device, with a period T_{w} separating two clock pulses corresponding to the frequency F_{w}. The axis 2 represents time and the clock pulses on an output of the device, with a period Tᵣ separating two clock pulses corresponding to the frequency Fᵣ. By way of example a message composed of four quanta of data is processed. It includes a message header H followed by quanta Q₁, Q₂ and Q₃. A quantum corresponds for example to a quantity of data of one, two or four bytes.

The “store and forward” routing will store in memory, in the form of a queue (FIFO), the input message composed of the quanta H, Q₁, Q₂ and Q₃. At an instant t₁, the quantum H arrives at the input and is stored in memory, then the quanta Q₁, Q₂ and Q₃ respectively arrive and are stored at the instants t₂, t₃ and t₄ corresponding to consecutive gating pulses of the input clock. The header H of the message contains information including the size of the said message and its destination. As soon as the message is stored entirely, on the next pulse t₅ of the clock of the output on which the autonomous switching means forwards the message, the header quantum H is forwarded, followed respectively, at the subsequent output clock gating pulses t₆, t₇ and t₈, by the quanta Q₁, Q₂ and Q₃.

As shown by FIG. 1, there is then a significant end of message latency, in this example equal to 2×T_{w} separating the instants t₄ and t₈, but no intra-message holes. An intra-message hole is the name given to a clock gating pulse on which no quantum of a message is forwarded, lying between two clock-gating pulses for which a quantum of the message is forwarded.

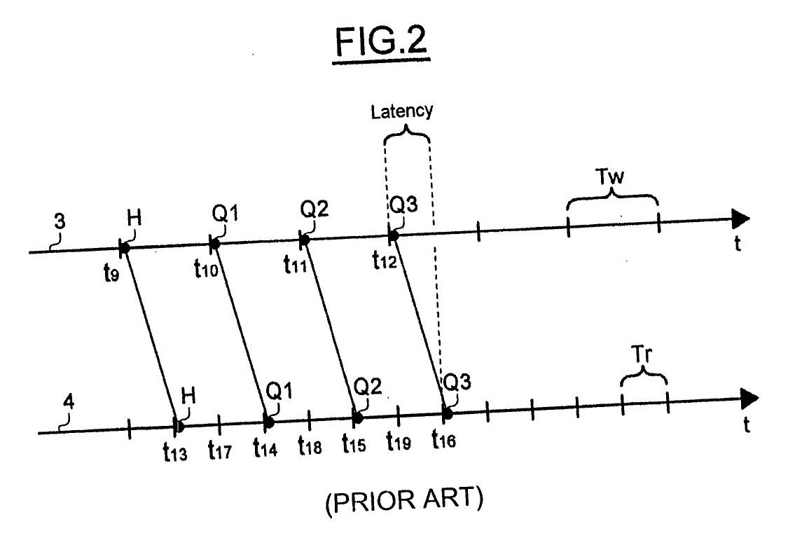

FIG. 2 illustrates the “wormhole” algorithm used by a prior art device including an autonomous switching means 5 and a storage means 7 of first in first out type with an input and an output, for at least one of the inputs of the device, respectively having clock gating frequencies F_{w} and Fᵣ. In this example, the clock gating frequencies are such that Fᵣ=2×F_{w}. Axis 1 represents time and the clock pulses on an input of the device, with a period T_{w} separating two clock pulses corresponding to the frequency F_{w}. Axis 2 represents time and the clock pulses on an output of the device, with a period Tᵣ separating two clock pulses corresponding to the frequency Fᵣ. As an example we shall deal with a message composed of four quanta of data, a message header H followed by the quanta Q₁, Q₂ and Q₃, which is identical to the example described in FIG. 1.

The “wormhole” strategy stores in memory, in the form of a FIFO queue, the input message composed of the quanta H, Q₁, Q₂ and Q₃. At an instant t₉, the quantum H arrives at the input and is stored in memory 7, then the quanta Q₁, Q₂ and Q₃ respectively arrive and are stored at the instants t₁₀, t₁₁ and t₁₂ corresponding to consecutive input clock gating pulses. As soon as the first, header quantum is stored at the instant t₉, the latter is forwarded on the next pulse t₁₃ of the clock of the output on which the autonomous switching means forwards the message. Likewise, respectively, for the quanta Q₁, Q₂ and Q₃, as soon as one is stored in the memory 7, respectively at the instants t₁₀, t₁₁ and t₁₂, it is, immediately upon the gating pulse of the output clock following the gating pulse of the clock of the input on which the quantum arrives, respectively at the instants t₁₄, t₁₅ and t₁₆ forwarded by the autonomous switching means.

As may be seen in FIG. 2, the end of message latency is reduced, here equal to Tᵣ, i.e. four times smaller than in the example of FIG. 1. However, on the other hand, a large number of intra-message holes is introduced, here three, for a message of four quanta, at the instants t₁₇, t₁₈ and t₁₉. This results in nonoptimization of the use of the bandwidth of the network and message integrity control that cannot in fact be done at the level of the router, but only at the level of the final agent.

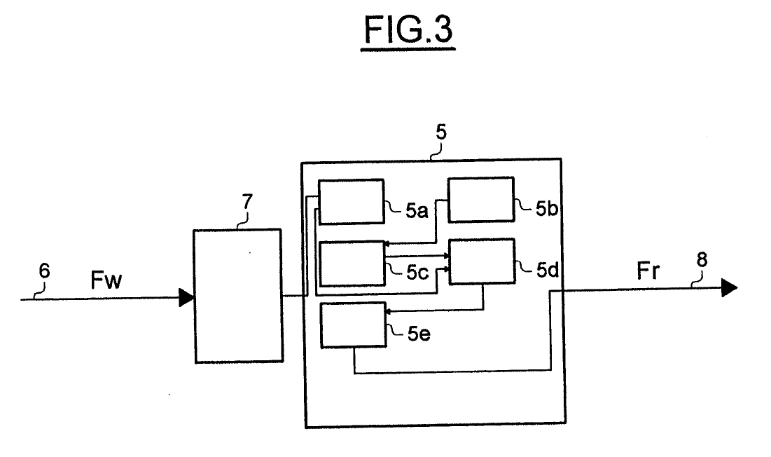

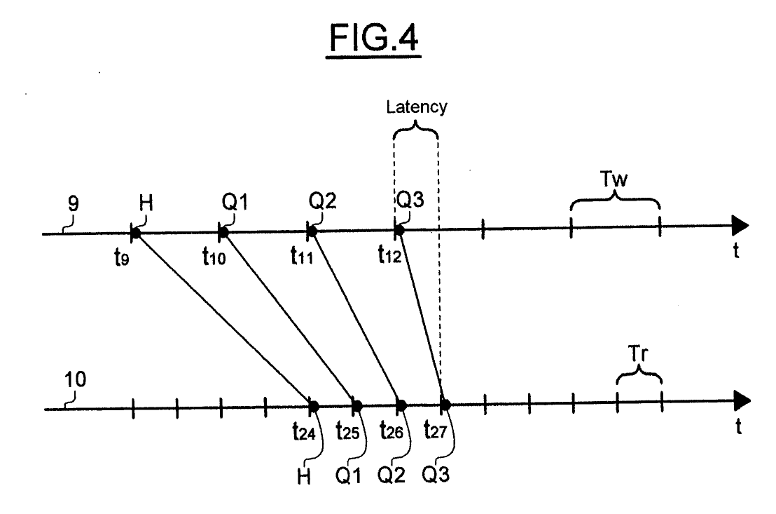

FIG. 3 represents a device according to an embodiment, including an autonomous switching means 5, and at least one input 6 furnished with a storage means 7 of FIFO queue type with an input and an output, and at least one output 8. The frequency of the gating clock of the input 6 is F_{w}, and frequency of the gating clock of the output 8 is Fᵣ. The autonomous switching means 5 implements the method described with reference to FIG. 4. It includes a means 5a of processing data, for example the reading of the length L of the message in the header quantum H and the determination of the quantity of data present in the memory 7, a means 5b of determining the clock gating frequency of the input on which the message arrives and of determining the clock gating frequency of the output on which the message is forwarded. It also includes a means of calculation 5c, and a means of comparison 5d. The means of calculation 5c performs the calculation of a coefficient α equal to

$$Max ( 0 ; 1 - \frac{{F}_{w}}{{F}_{r}} ) ,$$

and the means of comparison 5d compares the quantity of data present in the memory 7, with the product α×L. The means 5a of processing forwards the length L of the message and the quantity of data stored in the memory 7 to the means of comparison. The means 5b supplies the clock gating frequencies F_{w} and Fᵣ to the means 5c of calculation, which supplies the coefficient α to the means of comparison 5d. The means of comparison 5d forwards an item of information to a means 5e for triggering the forwarding of the message when the quantity of data stored in the memory 7 is greater than the product α×L, and the means 5e triggers the forwarding of the message.

FIG. 4 describes the forwarding of a message of quanta H, Q₁, Q₂ and Q₃. The quanta H, Q₁, Q₂ and Q₃ arrive at the input of the device respectively at the instants t₂₀, t₂₁, t₂₂ and t₂₃ corresponding to successive clock gating pulses of the input on which the message arrives, of frequency F_{w}, and are stored in the memory 7.

In the example of FIG. 4, the clock gating frequencies are such that Fᵣ=2×F_{w}. Axis 9 represents time and the clock pulses on the said input of the device, with a period T_{w} separating two clock pulses corresponding to the frequency F_{w}. Axis 10 represents time and the clock pulses on an output of the device, with a period Tᵣ separating two clock pulses corresponding to the frequency Fᵣ.
The autonomous switching means 5 calculates the coefficient α defined by the relation:

$$α = Max ( 0 ; 1 - \frac{{F}_{w}}{{F}_{r}} ) .$$

The coefficient α serves to perform, for example by the autonomous switching means 5, a comparison between the quantity of data stored in the memory 7, and the product of the length L of the message times the coefficient α. The length L of the message is contained in the header H. As soon as the quantity of data stored in memory 7 is greater than the product α×L, the forwarding of the said message is triggered starting from the next clock gating pulse of the selected output. In the example, this clock gating pulse of the selected output corresponds to the instant t₂₄. Then, at each successive next clock gating pulse t₂₅, t₂₆ and t₂₇, the quanta Q₁, Q₂ and Q₃ are respectively forwarded.

This method therefore makes it possible to keep a minimum end of message latency, as in the case of the “wormhole” algorithm, here equal to Tᵣ, but without inserting intra-message holes. In this way one in fact creates inter-message holes, and this will make it possible to increase the overall throughput of the network while easily being able to implant a message in these inter-message holes.

In the limit cases, such as for example for the cases where α=0, i.e. when F_{w} is much greater than Fᵣ or when F_{w}=Fᵣ, then the routing coincides with that of the “wormhole” algorithm. In the case where F_{w} is much less than Fᵣ, then α=1, and the routing coincides with that of the “store and forward” algorithm.

Stated otherwise, in the limit cases, known routing algorithms are used, and in the other cases, a novel routing is used.

When the frequencies F_{w} and Fᵣ are known, α is known and fixed by the user, and may be stored so as not to be endlessly recalculated.

When the gating clocks are regular, that is to say if the clock pulses are sent in a recognizable manner, even when no data is forwarded, it is easy to calculate the ratio of the frequencies.

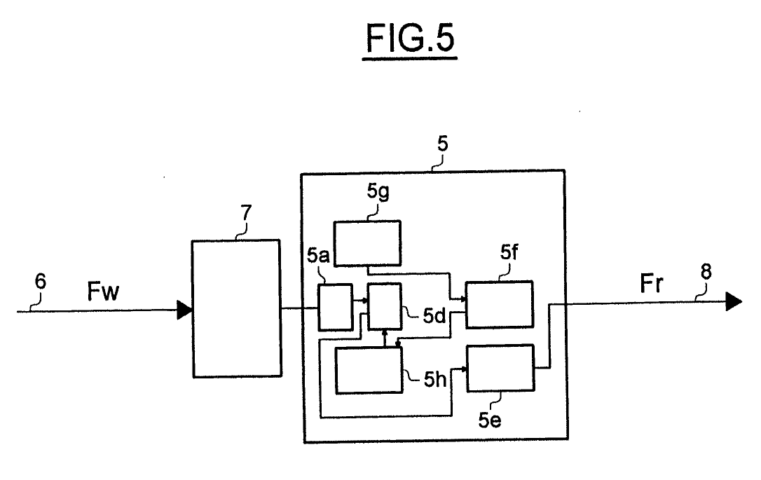

When the instability of the magnitudes used does not make it possible to calculate a as described above, another applicational aspect, represented in FIG. 5, is to slave α to the presence of intra-message holes, by adjusting a so as to make the number of intra-message holes tend towards a very small number, for example one intra-message hole every 10,000 quanta forwarded. Stated otherwise, if intra-message holes are present, α is small and it can then be increased, and if no intra-message hole is present, α is large and it can be decreased. The device also includes the means 5d of comparison and the means 5e for triggering forwarding which were described above, and furthermore, a slaving means 5f for slaving α as described previously, a means 5g for determining the number of intra-message holes, which forwards this information to the slaving means 5f, and a means 5h managing the value of α. The means 5h generates a first value of α, which lies between 0 and 1, forwarded to the means of comparison 5d. The means 5g estimate the rate of intra-message holes, and forward it to the slaving means 5f. The means of comparison 5d forwards an item of information to a means 5e for triggering the forwarding of the message when the quantity of data stored in memory 7 is greater than the product α×L, and the means 5e triggers the forwarding of the message. If the rate of intra-message holes is too large, with respect to a predetermined value, for example 1 in 10 000, the slaving means 5f forwards an item of information to the means 5h, which will generate a new, higher value of α, and conversely, if the rate of intra-message holes is too small with respect to the said predetermined value, the slaving means 5f forwards an item of information to the means 5h, which will generate a new, lower value of α.

The invention therefore makes it possible to implement a routing algorithm making it possible to improve the throughput in an interconnection network, while keeping a minimum end of message latency.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. A method of forwarding a message in a device, the device comprising an autonomous switching means comprising at least one output, and at least one input comprising a storage means provided with an input and an output, the method comprising:
formulating a coefficient representative of the ratio of the input clock gating frequency and output clock gating frequency;
comparing the quantity of data stored in the storage means of the input at which the message arrives to the product of the coefficient and the length of the message, and
forwarding the message when the quantity of data stored in the storage means of the input at which the message arrives is greater than the product of the coefficient times the length of the message.

2. The method according to claim 1, wherein forwarding of the message is moreover decided when the message is completely stored in the storage means of the input at which the message arrives.

3. The method according to claim 2, wherein forwarding of the message is furthermore decided when the storage means of the input at which the message arrives is full.

4. The method according to claim 3, wherein the message comprises a header, and wherein the length of the message is furthermore recovered in the header of the message.

5. The method according to claim 4, wherein the coefficient is formulated through the following relation:
$$α = Max ( 0 ; 1 - \frac{{F}_{w}}{{F}_{r}} )$$
in which F_{w} is the write or input clock gating frequency of the input on which the message arrives, Fᵣ is the read or output clock gating frequency on the output on which the message is forwarded, and Max is the maximum function.

6. The method according to claim 5, wherein when the input clock gating frequency and output clock gating frequency are known constants, the coefficient is constant and is stored.

7. The method according to claim 5, wherein when the clocks gating the inputs and the outputs are regular, the means of prediction comprises a means for calculating the ratio of the said input frequency and output frequency.

8. The method according to claim 5, wherein the said parameter is slaved to a predetermined rate of presence of intra-message holes in the messages.

9. A device for forwarding a message comprising:
an autonomous switching means;
at least one input, the input comprising a storage means provided with an input and an output;
a means for formulating a coefficient representative of the ratio of the input clock gating frequency and output clock gating frequency of an output on which the message is forwarded;
a means of comparing the quantity of data stored in the storage means of the input at which the message arrives with the product of the coefficient and the length of the message, calculated by a means of calculation; and
a means of triggering the forwarding of the message when the means of comparison detects a quantity of data stored in the storage means of the input at which the message arrives that is greater than the product of the coefficient times the length of the message.

10. The device according to claim 9, wherein the means for triggering the forwarding of the message is able to activate itself moreover when the message is completely stored in the storage means of the input at which the message arrives.

11. The device according to claim 10, wherein the means of triggering the forwarding of the message is able to activate itself moreover when the storage means of the input at which the message arrives is full.

12. The device according to claim 11, wherein the message comprises a header, and wherein the device comprises a processing means able to recover the length of the message in the header of the message.

13. The device according to claim 9, wherein the storage means of the input on which the message arrives is of first in first out type.
